(19) United States
(12) Patent Application Publication
(10) Pub. No.: US 2025/0269520 A1
(43) Pub. Date: Aug. 28, 2025

(54) METHOD, APPARATUS, AND SYSTEM FOR HUMANOID LOCATION LEARNING FROM DEMONSTRATION

(71) Applicant: Arash Mayhari, Pensacola, FL (US)

(72) Inventor: Arash Mayhari, Pensacola, FL (US)

(21) Appl. No.: 18/584,026

(22) Filed: Feb. 22, 2024

(51) Int. Cl. B25J 9/16; B25J 19/02

(52) U.S. Cl. CPC B25J 9/161; B25J 9/163; B25J 9/1697; B25J 19/023

(57) ABSTRACT

A system and method for generating commands for robot locomotion planning or robot locomotion itself The input to the system is images and videos of actual human locomotion The output of the system is a series of commands—preferably comprising vectors with joint angles, center of mass location information, footpoints, and velocities.

### CROSS-REFERENCES TO RELATED APPLICATIONS

This non-provisional patent application claims the benefit of an earlier-filed provisional application. The parent application was assigned Application No. 63/312,465. The parent application listed the same inventor.

### STATEMENT REGARDING FEDERALLY SPONSORED RESEARCH OR DEVELOPMENT

Not applicable

### MICROFICHE APPENDIX

Not Applicable

### BACKGROUND OF THE INVENTION

### 1. Field of the Invention

The present invention pertains to the field of robotics. More specifically, the invention comprises a method, apparatus, and system for teaching humanoid robot locomotion via learning from demonstrations of actual human motion (and in some instances the motion of other animals).

### 2. Description of the Related Art

Squad operations traditionally involve the cooperative efforts of several human squad members. Such operations are common for first responders, military personnel, and police personnel. In a hazardous environment, it is obviously desirable to replace human squad members with robots. This is often a challenging objective, however. In urban environments, where rubble and complex interior passages prevent the use of wheeled robots, human squad members must still be used. A humanoid robot offers the potential to overcome these issues. A humanoid robot that is capable of mimicking human motion can—in theory—perform any task that a human squad member can perform.

Building search and clearing is a good example of a challenging environment for squad operations. The tactics and equipment used for these operations have not changed appreciably since World War II. Current tactics are still very risky. Squads rely on stealth, speed, and surprise to reduce the risk. However, when engaging an opposing force in the field of its choosing, surprise is hard to achieve. In addition, the need for speed requires squad members to make split-second life or death choices.

A humanoid robot that is capable of functioning as a squad member is obviously useful in many environments. The level of maneuverability, durability, autonomy, and search skills required for a military environment are also effective in first responder and disaster scenarios. This will significantly expand emergency response capabilities—allowing robots to function as human avatars. This will allow emergency personnel to remain in relative safety, with robots entering hazardous emergency environments.

The design of a robotic locomotion controller that can function in a complex environment—such as found in a disaster scenario—is extraordinarily complex. On the other hand, human beings are readily capable of planning and executing the complex motions needed to move and operate in such an environment. The present invention proposes to use learning from demonstrated human motion captured via video data. Once the human motion is learned, the system will generate a set of values for autonomous humanoid robot motion.

### BRIEF SUMMARY OF THE INVENTION

The present invention comprises a system and method for generating commands for robot locomotion planning or robot locomotion itself. The input to the system is images and videos of actual human locomotion. The output of the system is a series of commands—preferably comprising vectors with joint angles, center of mass location information, footpoints, and velocities.

### BRIEF DESCRIPTION OF THE SEVERAL VIEWS OF THE DRAWINGS

FIG. 1 is a schematic view showing the overall concept of the present invention.

FIG. 2 is an elevation view, showing target points and path planning for an instance of robot locomotion.

FIG. 3 is a block diagram showing computing system components used in an embodiment of the invention.

FIG. 4 is a block diagram, showing the process carried out in an embodiment of the invention.

FIG. 5 is a block diagram, showing the process carried out in an embodiment of the invention.

FIG. 6 is a block diagram, showing the process carried out in an embodiment of the invention.

FIG. 7 is a block diagram, showing the process carried out in an embodiment of the invention.

### DETAILED DESCRIPTION OF THE INVENTION

The control system for a humanoid robot locomotion system preferably consists of a low-level controller and a high-level controller. The high-level controller performs path planning based on developed algorithms. This feature means that for every new terrain or movement, the path-planning has to be redesigned. The output of the path-planner is a series of footstep locations, positions for the robot's center of mass, values for the robot's joint angles, and values for the robot's joint angle rates of change.

The present invention proposes to learn from demonstrations of actual human motion (bipedal and quadrupedal). This process replaces the hardcoded path planning algorithms for humanoid robot locomotion. The proposed method learns the human motion from video data of actual human motion. The data preferably includes values for footstep locations, center of mass, joint angles, and joint angle rates of change. The inventive process will autonomously generate a set of values (perform path planning) for a humanoid robot.

The preferred embodiments will incorporate some or all of the following features:
(1) Learning humanoid robot locomotion from videos of humans walking, running, jumping. etc.—captured by cameras or presented by files of existing data to the inventive system;
(2) Using generative adversarial networks and variational autoencoders to learn and generate humanoid robot locomotion from data of actual human locomotion;
(3) Adjusting and fine tuning the learned locomotions using a reinforcement learning algorithm;
(4) Outputting a set of commands configured to control humanoid robot locomotion including joint angles, position, speed, and torques. These values are sent to the robot controller. In this case, the robot controller will do the path planning and the proposed system configures the path planning; and
(5) Replacing the whole robot controller with the inventive system. In this case, the proposed system will configure the path planning and perform the path planning.

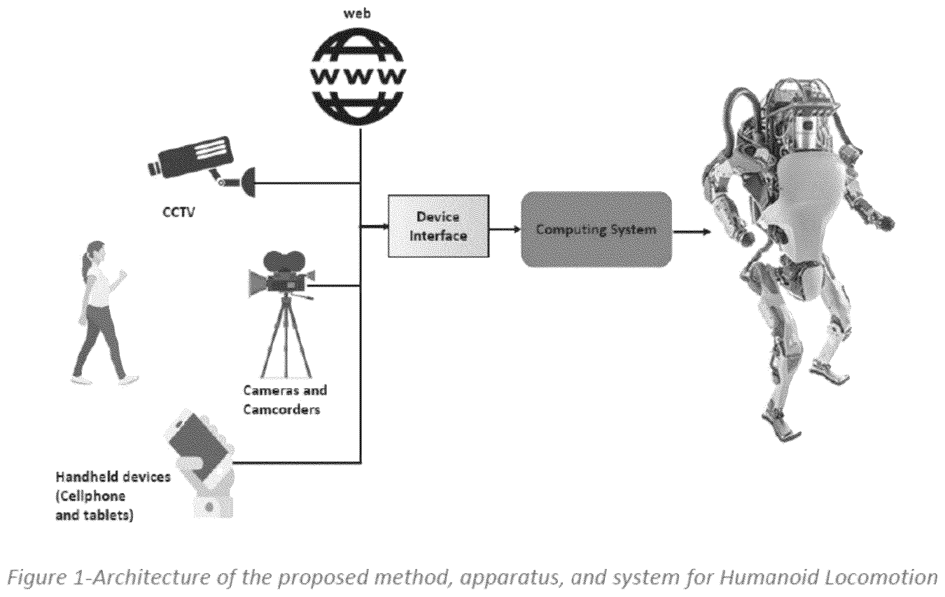

FIG. 1 shows a top-level depiction of the inventive method, apparatus, and system for humanoid robot locomotion. Video of actual human locomotion is captured by any suitable device—sch as a cell phone, a stationary video camera, or CCTV. Additional video of actual human locomotion can be retrieved from data files via the Internet or other file storage systems. The input data feeds into a Device Interface. Simply stated, the input to the system comprises images and videos obtained from camera live streams and data files.

The output of the system is a series of vectors that are used to control a humanoid robot. Each vector contains joint angles, the position of the center of mass, the positions of the footprints, and their velocity. The method operates the same for bipedal robots (humanoid robots) and quadrupedal robots. This series of output vectors is sent to the robot controller.

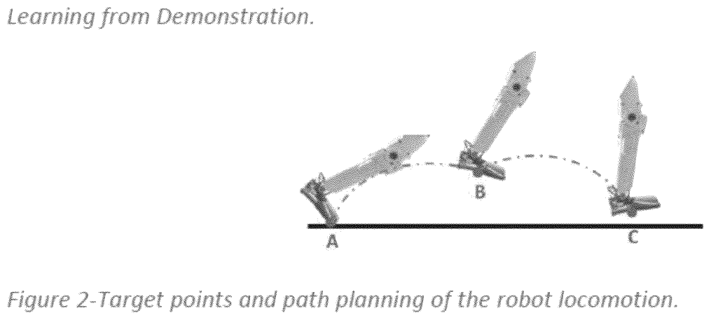

FIG. 2 provides a simple depiction of the type of information that can be extracted from the frames of the videos and sent as commands to the robot controller. Target points (A,B,C) are extracted from the frames of the videos and sent as commands to the robot controller. The robot controller performs the path planning—the phantom lines shown in FIG. 2—and controls the execution between target points.

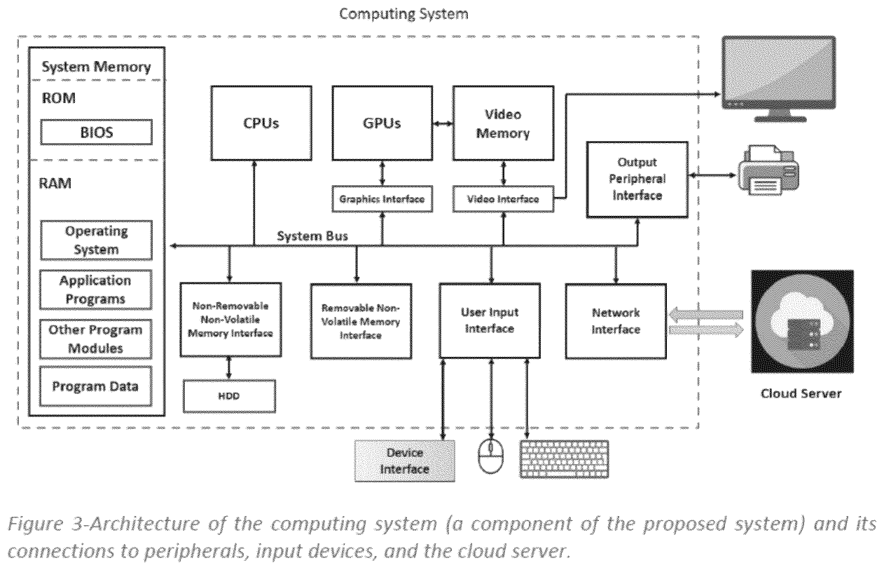

FIG. 3 shows a block diagram of an exemplary computer system that is used in an embodiment of the invention. The inventive system is deployed on the computing system presented and is executed by the system components, the cloud server, and its peripherals. The processing system includes two steps-training and then deployment of the trained system.

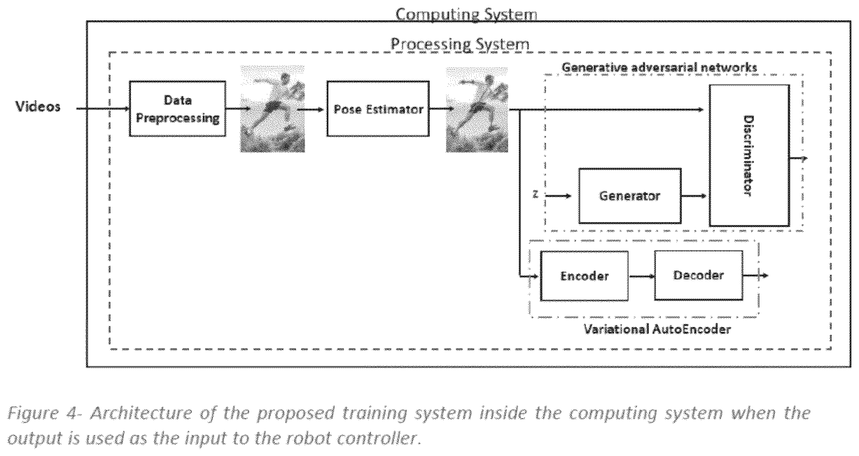

FIG. 4 depicts an embodiment of the training system. There are four major components—data preprocessing, a pose estimator, generative adversarial networks, and a variational autoencoder.

The data preprocessing component preprocesses and cleans the input images and videos. This includes reducing the noise, adjusting the light, cropping, and separating the human being studied from other objects in the scene.

The pose estimator estimates the pose of the human in the data for each frame—using a pose estimation algorithm. The algorithm will provide a pose vector for each frame. The algorithm extracts the position of all joints, hands, feet, etc. of the human subject. Then, the angles, position, speed, and torque are calculated from the extracted poses (including comparison of a sequence of poses).

The generative networks portion includes several components. While a discussion of generative adversarial networks is beyond the scope of this disclosure, those skilled in the art will know that these components match an output distribution as close as possible to a reference distribution. The embodiment show used GANs and Variation AutoEncoders (VAEs) to generate pose vectors (including joint angles, velocity, the locations of footpoints, and the location of the center of mass). The GAN consists of two modules—a generator and a discriminator. The generator learns to generate the sequence of pose vectors. The discriminator is used only in training to enhance the performance of the generator.

The VAE consists of two modules—an encoder and a decoder. These networks (generator, discriminator, encoder, and decoder) consist of multiple convolutional and fully connected layers, and recurrent neural networks that learn the sequences of pose vectors for humanoid locomotion.

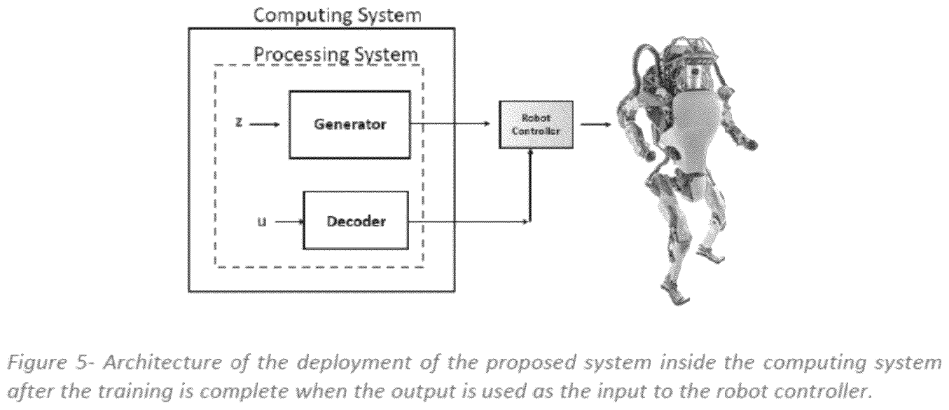

FIG. 5 illustrates an exemplary deployment of the inventive system. During the deployment, the generator of the GAN and the decoder module of the VAE are used to generate joint angles, positions, speed, and torque. These generated configurations are sent to the robot controller for path planning and execution.

In the embodiments depicted in FIGS. 1-5, the system generates configurations that are sent to a separate robot controller. In a second class of inventive embodiments, the system will replace the robotic controller as well. Thus, in this second class of embodiments, commands from the proposed system will be sent directly to the robot (rather than a separate robot controller). Looking again at FIG. 2, the target points (red circles) as well as the path (phantom line) are calculated by the proposed system and sent directly to the robot controller.

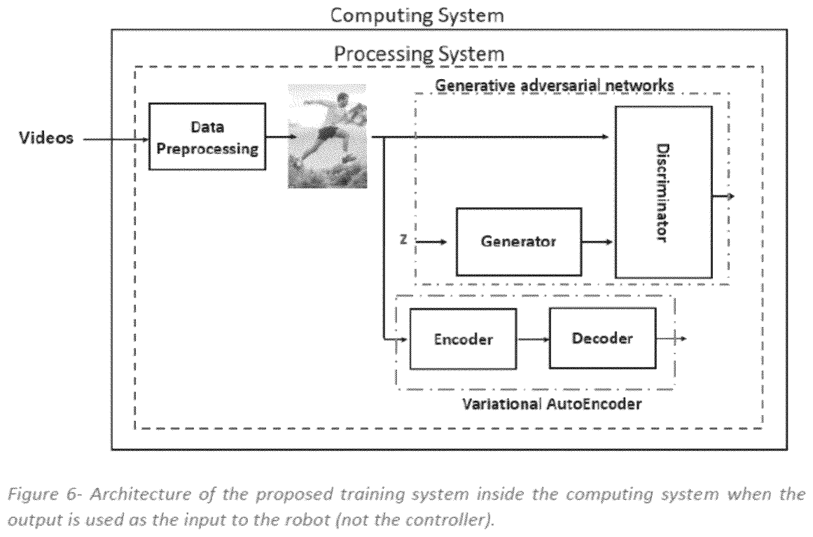

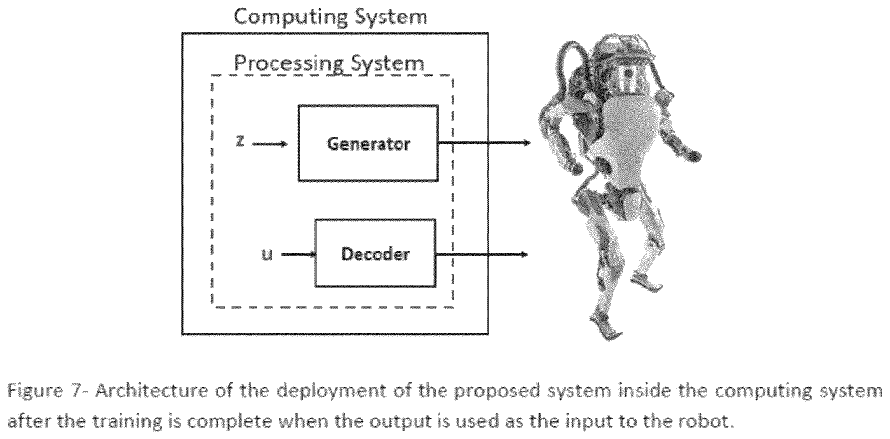

FIG. 6 shows the training system for this second class of embodiments. It is similar to the first class except that it does not have the pose estimation component. Thus, the input framed are sent directly to the discriminator after preprocessing. The deployment is also the same as for the previous approach except that the output of the generator and the decoder are sent directly to the robot (as shown in FIG. 7). In the deployment shown in FIG. 7, a reinforcement learning algorithm is used. This fine tunes the commands sent by the system. The reinforcement learning algorithm will use the commands sent by the proposed system as the baseline (inverse reinforcement learning) to perfectly perform and execute the path planning.

The preceding description contains significant detail regarding the novel aspects of the present invention. It is should not be construed, however, as limiting the scope of the invention but rather as providing illustrations of the preferred embodiments of the invention. Thus, the scope of the invention should be fixed by the claims ultimately drafted, rather than by the examples given.

Having described my invention, I claim:

1. A method for controlling motion of a robot, comprising:
(a) providing a processor having an associated memory;
(b) providing a pose estimation algorithm as software running on said processor;
(c) providing captured video data of a motion of a human subject to said pose estimation algorithm;
(d) said pose estimation algorithm extracting from said video data a position of all hands, feet, and joints of said human subject, thereby determining a plurality of extracted poses of said human subject;
(e) said pose estimation algorithm calculating a series of vectors describing an angle, a speed, a position, and a torque for each moving portion of said human subject;
(f) providing a robot having a robot controller;
(g) providing said series of vectors to said robot controller; and
(h) said robot controller using said series of vectors to control said motion of said robot.

2. The method for controlling motion of a robot as recited in claim 1, wherein the captured video data is captured using a cell phone.

3. The method for controlling motion of a robot as recited in claim 1, wherein the captured video data is captured using a video camera live stream.

4. The method for controlling motion of a robot as recited in claim 1, wherein said series of vectors includes target points for a left foot and a right foot of said human subject.

5. A method for controlling motion of a robot, comprising:
(a) providing a processor having an associated memory;
(b) providing a pose estimation algorithm as software running on said processor;
(c) providing captured video data of a motion of a human subject to said pose estimation algorithm;
(d) said pose estimation algorithm extracting from said video data a series of target points for a right foot of said human subject;
(e) said pose estimation algorithm calculating a series of vectors describing a position and speed for said right foot of said human subject;
(f) providing a robot having a right foot and a robot controller;
(g) providing said series of vectors to said robot controller; and
(h) said robot controller using said series of vectors to control said motion of said right foot of said robot.

6. The method for controlling motion of a robot as recited in claim 5, wherein the captured video data is captured using a cell phone.

7. The method for controlling motion of a robot as recited in claim 5, wherein the captured video data is captured using a video camera live stream.

8. The method for controlling motion of a robot as recited in claim 5, wherein said series of vectors includes target points for a left foot and a right foot of said human subject.

9. A method for controlling motion of a robot, comprising:
(a) providing a processor having an associated memory;
(b) providing a pose estimation algorithm as software running on said processor;
(c) providing captured video data of a motion of a human subject to said pose estimation algorithm;
(d) said pose estimation algorithm extracting from said video data a series of target points for a right foot and a left foot of said human subject;
(e) said pose estimation algorithm calculating a series of vectors describing a position and speed for said right foot and said left foot of said human subject;
(f) providing a robot having a right foot, a left foot, and a robot controller;
(g) providing said series of vectors to said robot controller; and
(h) said robot controller using said series of vectors to control said motion of said right foot and said left foot of said robot.

10. The method for controlling motion of a robot as recited in claim 9, wherein the captured video data is captured using a cell phone.

11. The method for controlling motion of a robot as recited in claim 9, wherein the captured video data is captured using a video camera live stream.

12. The method for controlling motion of a robot as recited in claim 9, wherein said series of vectors includes target points for a left foot and a right foot of said human subject.
